(19) United States
(12) Patent Application Publication
(10) Pub. No.: US 2019/0089804 A1
(43) Pub. Date: Mar. 21, 2019

(54) Crowd-sourced content tracking

(71) Applicant: TENSERA NETWORKS LTD., Hod Hasharon (IL)

(72) Inventors: Daniel Yellin, Raanana (IL); Shimon Moshavi, Beit Shemesh (IL); Nimrod Mesika, Tel Aviv (IL)

(21) Appl. No.: 16/085,607

(22) PCT Filed: May 9, 2017
(86) PCT No.: PCT/IB2017/052683

§ 371 Date: Sep. 17, 2018

Related U.S. Application Data
(60) Provisional application No. 62/343,134, filed on May 31, 2016.
(60) Provisional application No. 62/473,389, filed on Mar. 19, 2017.

(51) Int. Cl. H04L 29/08

(52) U.S. Cl. CPC H04L 67/2842

(57) ABSTRACT

A method includes detecting, by a plurality of user devices (28) that access content on one or more content sources (24), content updates that occurred on the content sources, and reporting the content updates to a content-tracking processor (68). The content updates, which are reported by the plurality of user devices, are collected at the content-tracking processor, and at least some of the collected content updates are distributed to at least some of the user devices. The content is accessed by the user devices responsively to the content updates distributed by the content-tracking processor.

### CROSS-REFERENCE TO RELATED APPLICATIONS

This application claims the benefit of U.S. Provisional Patent Application 62/343,134, filed May 31, 2016, and U.S. Provisional Patent Application 62/473,389, filed Mar. 19, 2017, whose disclosures are incorporated herein by reference.

### FIELD OF THE INVENTION

The present invention relates generally to management of content accessed by user devices, and particularly to methods and systems for tracking content using crowd-sourcing.

### BACKGROUND OF THE INVENTION

Various systems and applications manage the access of content by user devices. For example, prefetching systems transfer new or updated content to the user device before the content is explicitly requested by the user. Discovery of new or updated content may be performed, for example, by continuously “crawling” the content available on the content sources.

### SUMMARY OF THE INVENTION

An embodiment of the present invention that is described herein provides a method including detecting, by a plurality of user devices that access content on one or more content sources, content updates that occurred on the content sources, and reporting the content updates to a content-tracking processor. The content updates, which are reported by the plurality of user devices, are collected at the content-tracking processor, and at least some of the collected content updates are distributed to at least some of the user devices. The content is accessed by the user devices responsively to the content updates distributed by the content-tracking processor.

In some embodiments, detecting the content updates includes, in a user device, looking-up a content item accessed by the user device in a content catalog cached in the user device. In an embodiment, distributing the content updates includes updating the cached content catalog. In another embodiment, looking-up the content item includes one of: detecting that the content item is not listed in the cached catalog, and detecting that a version of the content item being accessed by the user device differs from the version of the content item listed in the cached catalog.

In some embodiments the method further includes, in response to a detected update of a first content item, identifying that a second content item is related to the first content item, and distributing the content updates includes notifying one or more of the user devices of a relationship between the first and second content items. Identifying that the second content item is related to the first content item may include identifying that the second content item has a parent-child relationship with the first content item. Additionally or alternatively, identifying that the second content item is related to the first content item may include identifying that the first and second content items are predicted to be accessed by the same user. Further additionally or alternatively, identifying that the second content item is related to the first content item may include identifying that the first and second content items include different representations of a same content.

In an embodiment, the method further includes identifying that a given content item is personalized, and distributing the content updates includes selecting, based on the identification, which user devices to notify of a content update relating to the given content item. In another embodiment, the method further includes identifying that a given content item changes dynamically based on a parameter, and distributing the content updates includes notifying one or more of the user devices that the given content item is identified as changing dynamically.

In yet another embodiment, collecting the content updates includes combining the content updates reported by the user devices with additional content updates detected by crawler software that scans at least one of the content sources. In still another embodiment, distributing the content updates to the user devices includes distributing a given content update to only a selected subset of the user devices.

In some embodiments, reporting the content updates includes reporting, from a user device to the content-tracking processor, metadata relating to (i) content items accessed by the user device, or (ii) a state of the user device or a user of the user device while accessing the content items. In an embodiment, collecting and distributing the content updates is performed responsively to the metadata. In another embodiment, the method further includes identifying a relationship pertaining to one or more of the content items, responsively to the metadata.

In some embodiments, accessing the content by the user devices includes prefetching one or more of the content items, responsively to the content updates distributed by the content-tracking processor. In a disclosed embodiment the method includes, in response to a detected update of a first content item, identifying by the content-tracking processor a relationship between the first content item and a second content item, and prefetching the content items includes setting a prefetching policy based on the identified relationship. In some embodiments, distributing the content updates includes distributing a content update, which was collected from a first user device, to a second user device that is different from the first user device. In some embodiments, the method further includes using a content update, which was collected from a first user device, only by one or more second user devices that are different from the first user device.

There is additionally provided, in accordance with an embodiment of the present invention, a system including a plurality of user devices and a content-tracking processor. The user devices are configured to access content on one or more content sources, to detect content updates that occurred on the content sources, and to report the content updates. The content-tracking processor is configured to collect the content updates reported by the plurality of user devices, and to distribute at least some of the content updates to at least some of the user devices.

There is further provided, in accordance with an embodiment of the present invention, an apparatus including an interface for communicating over a communication network, and a processor. The processor is configured to receive over the communication network, from a plurality of user devices that access content on one or more content sources, content updates that occurred on the content sources and were detected by the user devices, to collect the content updates reported by the plurality of user devices, and to distribute at least some of the content updates to at least some of the user devices.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for crowd-sourced content tracking, in accordance with an embodiment of the present invention;

FIG. 2 is a flow chart that schematically illustrates a method for crowd-sourced content tracking, in accordance with an embodiment of the present invention; and

FIG. 3 is a block diagram that schematically illustrates a system for prefetching based on crowd-sourced content tracking, in accordance with an embodiment of the present invention.

### DETAILED DESCRIPTION OF EMBODIMENTS

### Overview

User devices, such as smartphones and personal computers, commonly run applications that access content provided by content sources. Example applications include general-purpose browsers that access Web sites, news applications, electronic commerce applications, and many others.

Content providers typically update the content available on their content sources, e.g., by adding new content items or by updating existing content items. In many cases it is important for user devices to be aware of content updates as quickly and as efficiently as possible. For example, when a user device employs content prefetching, information regarding content updates is helpful in optimizing prefetching operations.

One possible solution for tracking content updates is to run “crawler” software that scans the content source and identifies new and updated content items. Crawlers, however, have inherent drawbacks that limit their performance and usefulness. For example, crawlers typically jump from one content item to another by following links (e.g., hyperlinks) embedded in the content items. In some cases, however, such links may be dynamic, e.g., change depending on user identity, time or other parameter, or they may be embedded in executable scripts. In such cases, the links followed by the crawler are likely to differ from the links followed by a genuine user device. As another example, in some cases content providers identify and block crawlers.

Embodiments of the present invention that are described herein provide improved techniques for tracking content updates, based on crowd-sourcing. In some disclosed embodiments, a plurality of user devices access content on a content source. When a user device detects a content update (e.g., relative to a previously-distributed content catalog), the user device reports the detected content update to a centralized Content Tracking (CT) subsystem. The CT subsystem collects such reports from the plurality of user devices. When appropriate, the CT subsystem re-distributes the information regarding content updates to the user devices, e.g., by updating the content catalog. In this manner, each user device is notified of content updates discovered by the entire plurality of user devices.

In some embodiments, the user devices and/or the CT subsystem also use crowd-sourcing techniques for identifying relationships between content items. More particularly, upon detecting a new or updated content item, the user devices and/or the CT subsystem may identify a relationship to a second content item that is related to the updated content item. Identifying relationships may comprise, for example, identifying child-parent relations between content items, identifying content items that comprise different representations of the same content, or identifying content items that are likely to be consumed by the same user. These relationships may also be distributed to the user devices.

In various embodiments, the user devices may use the information regarding content updates in various ways, to improve performance and user experience. For example, user devices that employ prefetching can use this information to better decide when to prefetch content from the content source.

Since the disclosed techniques are based on crowd-sourcing from a large number of diverse user devices, they are able to detect content updates rapidly and with high reliability. Moreover, since the disclosed techniques are based on content updates detected by genuine user devices, they tend to be highly accurate and useful for future content access. Furthermore, the disclosed techniques track content updates without a need for any dedicated interaction with the content source. As such, the above-described drawbacks of crawler software can be avoided. Nevertheless, in some embodiments the CT subsystem uses both crowd-sourcing and crawling techniques in a complementary manner.

Various additional system configurations, ancillary features and variations are described below.

### System Description

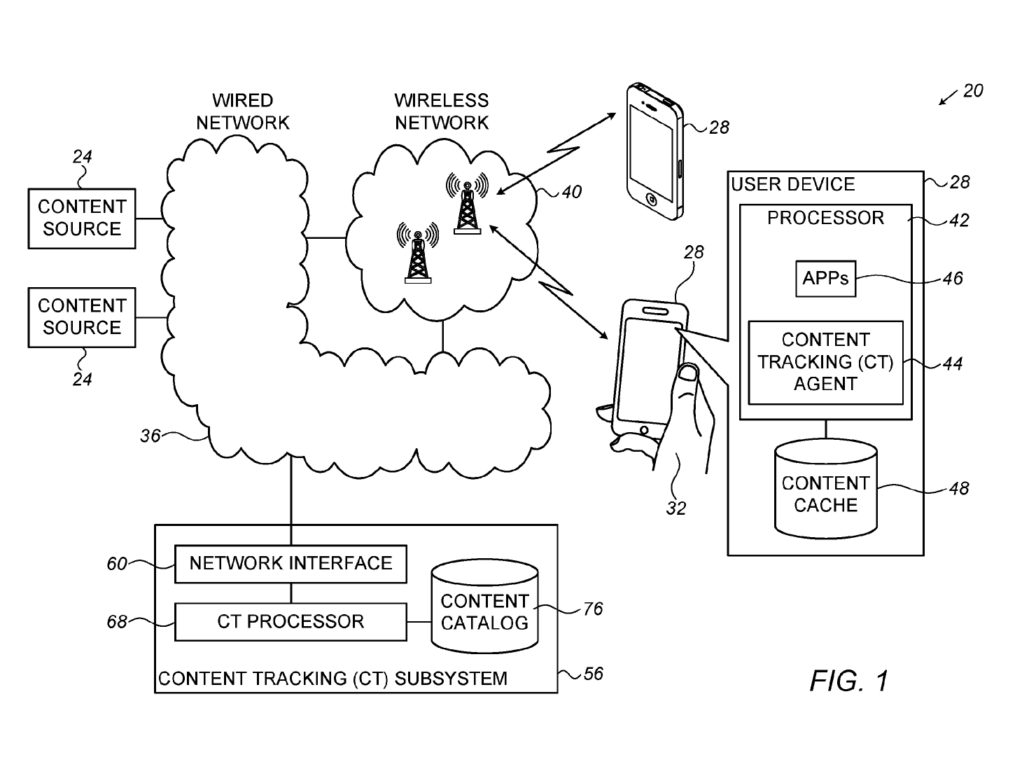

FIG. 1 is a block diagram that schematically illustrates a system 20 for crowd-sourced content tracking, in accordance with an embodiment of the present invention. In the present example, system 20 comprises one or more content sources 24 that provide content for use by multiple user devices 28 operated by users 32. A system of this sort may be operated, for example, by content providers, by wireless service providers, or by some third party. Although the embodiments described herein refer mainly to wireless networks, the disclosed techniques can also be used in various wired networks.

Content sources 24 may comprise, for example, Web sites, portals, Content Delivery Networks (CDNs), data centers or any other suitable type of content sources. User devices 28 may comprise, for example, cellular phones, smartphones, tablet computers, laptop computers, wearables, mobile car devices, smart TVs, or any other suitable device that is capable of presenting content to a user and has wired or wireless communication capabilities. FIG. 1 shows only two user devices for the sake of clarity. Real-life implementations, however, typically comprise a large number of user devices 28.

The various elements of system 20, e.g., content sources 24 and user devices 28, communicate with one another over one or more wired or wireless communication networks. In the present example, content sources 24 are accessed over a wired network 36 (e.g., the Internet) that is connected to a wireless network 40 (e.g., a cellular or Wi-Fi network) that serves user devices 28. The end-to-end content paths from the content sources to the user devices therefore typically traverse both wired and wireless links. In the present context, the network or combination of wireline and/or wireless networks over which content is delivered from sources 24 to user devices 28 is referred to as “a communication network” or “a network.”

Each user device 28 typically comprises one or more suitable output devices for presenting content items to user 32, e.g., a screen or display for displaying content items, a loudspeaker or other audio output device for sounding audio content, or any other suitable output devices. In addition, each user device 28 comprises suitable radio and baseband circuitry (not shown in the figure) that serves as an interface for connecting to network 40.

Each user device 28 further comprises a processor 42 that, among other tasks, runs one or more user applications (“Apps”) 46 that consume content provided by content sources 24. Apps 46 may comprise, for example, general-purpose browser applications or dedicated apps that access specific content sources. Processor 42 also runs a Content Tracking (CT) agent 44, which participates in the crowd-sourcing content tracking techniques described herein.

Each user device 28 additionally comprises a respective content cache 48 for temporarily storing content items. Content items (e.g., Web pages) that are cached in cache 48 can be served to user 32 (e.g., displayed by apps 46 running in the user device) with small latency, without incurring the latency of content retrieval from content source 24.

FIG. 1 shows the internal structure of only one user device 28, for the sake of clarity. The various user devices 28 of system 20 typically have a similar internal structure.

In the example of FIG. 1, system 20 further comprises a Content Tracking (CT) subsystem 56 connected to network 36. CT subsystem 56 comprises a network interface 60 for connecting to network 36, a CT processor 68 that carries out the disclosed crowd-sourced content tracking techniques in conjunction with agents 44 in user devices 28, and a memory 76 that stores a content catalog.

### Crowd-Sourced Content Tracking

The content provided by content sources 24 is typically updated over time. In the context of the present patent application and in the claims, the term “content update” refers both to addition of new content items, and to updating of existing content items. In some embodiments, CT processor 68 (in CT subsystem 56) and CT agents 44 (running on processors 42 in user devices 28) carry out a crowd-sourcing process of tracking content updates on content sources 24.

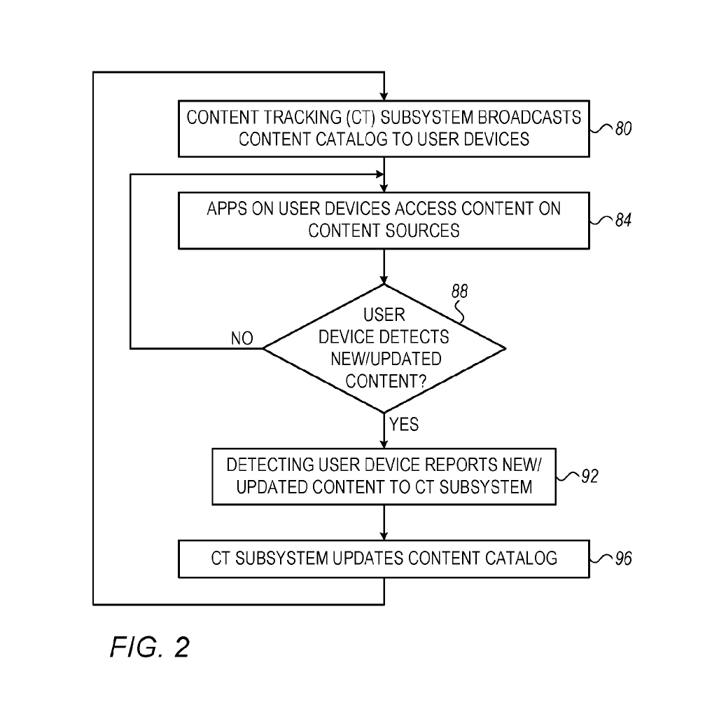

FIG. 2 is a flow chart that schematically illustrates a method for crowd-sourced content tracking, in accordance with an embodiment of the present invention. The method begins with CT processor 68 broadcasting the current content catalog to user devices 28, at a catalog distribution step 80. The content catalog typically specifies the various content items that are available on content sources 24.

In some embodiments each content source has its own separate catalog. In some embodiments the catalog also specifies the current version of each content item. Processor 68 may broadcast the entire catalog, or only incremental updates relative to the previously-distributed version, or any combination of the two schemes.

In each user device, processor 42 typically caches the content catalog received from CT processor 68 in cache 48. At a content accessing step 84, apps 46 on the various user devices 28 access desired content on content sources 24 using the catalog.

At an update checking step 88, CT agents 44 in the various user devices 28 check whether any of the content accessed by the respective user devices was updated. In an embodiment, each CT agent 44 monitors the content items accessed by apps 46 in the respective user device 28. For a given content item, CT agent 44 decides that the content item has been updated if, for example, the content item does not appear in the catalog cached at the user device. As another example, CT agent 44 may decide that the content item has been updated if the accessed version of the content item differs from the version number listed in the cached catalog. If none of the CT agents detects a content update, the method loops back to step 84.

When CT agent 44 in a certain user device 28 detects that a content item has been updated, the CT agent in question reports the content update to CT processor 68, at an update reporting step 92. The CT agent may report each update individually as it is detected, or accumulate multiple content updates before reporting them together, or use any other suitable reporting scheme. The report may also specify the version of the content item being accessed.

Thus, CT processor 68 receives over time multiple reports from multiple different user devices 28, which report content updates detected by the user devices. At a catalog updating step 96, CT processor 68 updates content catalog 76 to reflect the content updates reported by user devices 28. The method loops back to step 80 above, in which CT processor 68 broadcasts the updated catalog to user devices 28.

The method of FIG. 2 typically continues to update the content catalog over time. In this manner, each user device 28 is continuously provided with notifications that update the content catalog. The notifications are based on content updates detected by the plurality of user devices 28. In other words, in an embodiment, as soon as one user device 28 detects a content update, all other user devices are immediately notified of this update.

Processors 42 of user devices 28 may use the information regarding content updates (e.g., the updated content catalog) in any suitable way and for any suitable purpose. For example, CT agent 44 on a given user device may decide whether to alert the user or notify an app that certain accessed content is not up-to-date or that some new content is available on content sources 24. An example use case relating to content prefetching is described in detail further below.

In various embodiments, the content catalog may comprise any suitable information that is indicative of the current versions of content items, such as for example, a version number. In one embodiment, the catalog may record respective Hyper-Text Transfer Protocol (HTTP) entity tags (“etags”) of content items. In one embodiment, the catalog may record respective “last modified” dates and/or times of content items. In yet another embodiment, the catalog may record suitable signatures, such as Cyclic Redundancy Check (CRC) codes, calculated over the respective content items. Any such information enables CT agent 44 to compare the version of an accessed content item with the version of that content item listed in the catalog. A version mismatch might indicate that the content item was updated.

Some version indications, e.g., etag and last-modified date, may be obtained by CT processor 68 from the content source or content provider. Other version indications, e.g., CRC or other signature, may be calculated over the content items by CT processor 68. In some embodiments, such version indications might be calculated by the CT agent 44 at the device and reported to the CT Subsystem along with the content update report.

In an embodiment, when version indications are not available at the device, CT agents 44 may report to CT processor 68 any content item being accessed, regardless of whether or not the content item appears in the catalog. Upon receiving such a report, CT processor 68 may calculate a signature (e.g., CRC) over the current version of the content item. If the signature differs from the most recent previously-calculated signature of that content item, the CT processor may conclude that the content item has changed and decide to increment the version number for that item. This solution relieves the user device of the need to calculate signatures, but increases the number of reports from the user device to the CT subsystem.

### Crowd-Sourced Identification of Relationships Between Content Items

In some embodiments, system 20 uses crowd-sourcing techniques not only for detecting content updates, but also for identifying relationships between content items. Detecting relationships may be performed by CT processor 68, by CT agents 44, or by both. Typically, upon detecting that a certain content item has been updated, CT processor 68 and/or CT agents 44 may use crowd-sourcing techniques to identify a relationship with a second content item that is related to the updated content item.

One example relationship between content items is a “parent-child” relationship. In this context, when a first content item contains a second content item, the first content item is referred to as the “parent” and the second content item is referred to as the “child.” For example, a web page is regarded as the parent of images or scrips it contains. In an embodiment, upon detecting that a certain content item has been updated, CT processor 68 and/or CT agents 44 identify a parent of the updated content item (e.g., a Web page that contains links to the updated content item), or a child of the updated content item (e.g., a content item that the updated content item contains a link to).

In some embodiments, CT processor 68 identifies such relationships by analyzing the content update reports received from the multiple user devices. In some embodiments, upon reporting content updates, the user devices also report additional parameters relating to user activity, e.g., metadata relating to the items accessed by the user or to the user/device state at the time of the click. CT processor 68 may consider the additional parameters, typically by analyzing them over many user devices and over time, in identifying relationships between content items. Examples of such metadata might include an indicator of the parents or children of the content item, device type, model, orientation or other characteristic, URL and HTTP Request Headers (including cookies), device location, device velocity or other sensor state information, network type (e.g., Wi-Fi versus cellular), network link quality, click time of day and/or day of week, etc.

In an example embodiment, in addition to reporting content updates, CT agents 44 also report the Uniform Resource Locators (URLs) that were accessed in close time proximity to the detected content updates. These URLs can be helpful in determining parents or children of updated content items. CT processor 68 may also identify additional content items that were accessed in close time proximity to an updated content item. Such additional content items may, for example, share a common parent with the updated content item. Since these criteria are statistical, CT processor 68 typically identifies the relationships over reports of multiple user devices and over a time period, e.g., using machine learning processes.

Another type of relationship that can be identified between content items is access correlation, i.e., a high likelihood that a user who accesses one of the content items will also access the other content item within a small time interval. In one embodiment, for content items that are related in this manner, CT processor 68 may also learn the typical time proximity in which the content items are likely to be accessed. In some embodiments, CT processor 68 identifies such correlation and records it in the content catalog that is later distributed to the user devices. Access correlation between content items can be used by the user devices, for example in order to better decide which content updates are relevant for each user (or put in another way, which users should be alerted when a particular content update is detected).

Yet another type of relationship is between content items that are actually different representations of the same content. For example, different content items may comprise the same image represented with different size and/or different resolution. Such representations may be available depending, for example, on user preferences or on the available communication bandwidth (e.g., the type of communication link). As another example, different content items may comprise the same image that is adapted to different orientations (e.g., portrait vs. landscape) of the user device's display.

In some embodiments, CT processor 68 identifies content items that are different representations of the same content, and records this relationship in the content catalog that is later distributed to the user devices. The user devices may use this information in various ways. For example, if a certain content item is known to be customized to a particular type of user device, then other types of user devices may safely disregard updates to this content item. As another example, if a certain content item is known to only be made available to a user device with a Wi-Fi or strong cellular connection, then user devices with a weak cellular connection may safely disregard updates to this content item. Moreover, in these examples, if a content item is determined to not currently be relevant for a user then the CT processor 68 may decide not to notify the user of the content update.

In an embodiment, CT processor 68 may identify such a relationship by analyzing the content update reports received from the various CT agents 44. Parameters that can be reported by the CT agents and are useful in this context comprise, for example, parameters defined in the URL and HTTP Request Headers (including cookies), as well as records of content usage activity of the users. For example, if many users report an update relating to a similar URL but with some small changes (e.g., to indicate image size, resolution or orientation), and these content access operations generally occur immediately after accessing the same URL (e.g., the parent article that is linked to the different-resolution/size/orientation images), then CT processor 68 may conclude that the similar URLs point to different representations of the same image. In performing this analysis, CT processor 68 may parse and compare the URLs and/or headers of different content access operations (reported in the content update reports), possibly along with the order with which the content was accessed and other parameters.

In some practical cases, different user devices 28 may receive different representations of the same content item, even though they specify the same URL and HTTP request header when requesting to access the content. For example, a user device that accesses a content source via a fast Wi-Fi connection may be served a higher-resolution image than a user device accessing the same image via a slower cellular connection. As another example, user devices located in different geographical areas may access the same content via different Content Distribution Networks (CDNs). A faster, higher-quality CDN may provide a higher-resolution representation of an image than a slower, lower-quality CDN. Although CT controller 68 may identify such content items as being different (e.g., following CRC check), it should not regard one of these items as an update of the other. Thus, in some embodiments, CT processor 68 identifies that the content items are in fact different representations of the same image, and records this information in the catalog. In some embodiments, CT agents 44 may send in their content-update reports additional parameters that assist the CT processor in this analysis. Example parameters may comprise the user device location, the type and/or status of their wireless link (e.g., Wi-Fi vs. cellular), or any other suitable parameter.

In some embodiments, the CT processor analyzes the device reports in order to determine whether content item links are dynamic in some way. For example, the availability of the content item, the identity of the parents and/or children, or the position of a content item on a page, might change based on one or more parameters. For example, certain content might be at least partly personalized, i.e., customized or tailored depending on the identity of the user. In another example, certain content is modified based on the time of day or any other parameter.

In one such embodiment, the CT processor determines a relationship between content and a user or group of users, e.g., content that has been customized or tailored depending on the identity of the user. Some apps, for example, provide a personalized feed when initially opened by the user.

In some embodiments, CT processor 68 may detect that a certain feed is personalized, and attempt to deduce as much information as possible regarding the different content items that make up the feed for different users. In an example embodiment, CT processor 68 identifies, in the content catalog, all content items that are suspected of being used in a feed (across all users), and assumes that all these content items are relevant to all users. In another embodiment, CT processor 68 uses the associations between the identities of users 32 or devices 28 and the respective content update reports from agents 44, to identify which content items in a feed are relevant to which user. For example, CT processor 68 may cluster the users (or, equivalently, the user devices) into groups, and determine which content items are most likely relevant to each group.

In some cases of personalized content, content items that essentially convey the same content will differ slightly when accessed by different user devices 28. In some embodiments, CT processor 68 identifies such content items as related and records this information in the catalog that is distributed to the user devices.

### Additional Embodiments and Variations

In some embodiments, the disclosed crowd-sourcing content-tracking schemes are implemented in conjunction with crawling techniques, not instead of crawling techniques. For example, CT subsystem 56 may additionally comprise a crawler module (not shown in the figures) that crawls a content source 24 and reports content updates. The reports may be sent to CT processor 68, to CT agents 44, or to both. In this solution, the content-update reports from agents 44 and the content-update reports from the crawler may complement each other and increase the overall performance of detecting content updates.

In an embodiment, upon adding a content update to the content catalog, CT processor 68 may report this update to CT agents 44 using any suitable reporting scheme. Two non-limiting examples are Google Cloud Messaging (GCM) used in Android devices and Apple Push Notification (APN) used for iOS devices.

In some embodiments, CT processor 68 may decide on a user-by-user basis when to notify user devices of content updates added to the catalog. For example, CT processor 68 may send notifications more frequently to user devices whose agents 44 contribute more content updates, and vice versa. As another example, CT processor 68 may send notifications more frequently to user devices running apps that require tighter monitoring of content updates, and vice versa.

In an embodiment, CT processor 68 may notify only a selected subset of user devices 28, and not others, of a certain content update added to the catalog. For example, the CT processor may assess the user devices to which a certain content update is relevant, and send notifications only to those user devices. This assessment may be based, for example, on past content-access activity of the user devices and/or the apps they run.

In some embodiments, when a subset of user devices 28 are selected for notification that one or more relevant content updates are available, then all of the content updates (or the entire updated catalog) might be subsequently sent to each user device 28 of the subset. In other embodiments, the content or catalog updates delivered to the user devices might be personalized for each user device (or group of devices) based on which content items or content updates are assessed to be relevant for each user device (or group of devices).

In some embodiments, CT processor 68 may identify specific times-of-day as having a higher priority for sending content update notifications to user devices 28. For example, CT processor 68 may refrain from sending update notifications to a certain user device 28 during times-of-day in which that user device is usually inactive.

In some embodiments choosing content tracking priority level can be associated with choosing between different content tracking modes of operation—such as Guaranteed and Best Effort modes. In the guaranteed tracking mode, CT Subsystem 56 ensures that content updates are regularly reported to the user device 28 (e.g., at predefined guaranteed-mode tracking intervals). In the best-effort mode, the CT Subsystem 56 typically notifies the user device only as feasible using the available resources. For example, in the best-effort mode, tracking update notifications may be restricted to scenarios in which a particularly robust network connection exists, or limited to scenarios that do not involve a cellular connection. The guaranteed tracking mode may be utilized during one or more time-of-day intervals in which the likelihood of a user accessing a content source has been predicted to be high. Other considerations that can affect the choice between the guaranteed and best-effort modes include e.g., power consumption, device battery level, transmission cost, network congestion and/or server load. The choice of mode can also be made separately for different applications and/or content sources.

In some embodiments, a given CT agent 44 in a given user device 28 may request an updated catalog from CT processor 68, possibly in response to a content update notification. The decision as to when to request a new catalog may also depend on other factors related to the current state at the user device, such as the user-device battery level and network-connection type and/or quality. For example, CT agent 44 may be more likely to request a catalog update when connected to the network via a high-quality Wi-Fi link, as opposed to a lower-quality cellular link.

In some embodiments, CT processor 68 may compress the catalog before sending it to the user device. For example, CT processor 68 may identify and send only incremental changes to the catalog, relative to the previously sent version of the catalog.

In some embodiments, CT processor 68 may send catalog updates embedded in the content update notifications. Certain aspects of such a solution are addressed in detail in U.S. patent application Ser. No. 15/404,214, filed Jan. 12, 2017, which is assigned to the assignee of the present patent application and whose disclosure is incorporated herein by reference. For catalog updates that are small enough to fit within the available space of the content update notifications, this technique is an efficient way of keeping the catalogs up-to-date at the user devices, while minimizing the communication overhead between CT processor 68 and CT agents 44.

In various embodiments, the functionality of CT processor 68 and CT agents 44 may be implemented in various ways. In some embodiments, some or all of the functionality of CT processor 68 may be implemented in user devices 28. In other embodiments, some or all of the functionality of CT agents 44 may be implemented on the network side, e.g., in CT subsystem 56. In some embodiments, CT agent 44 is embedded in an app running on the user device, or as a Software Development Kit (SDK) embedded in an app. Alternatively, the functionality of CT agent 44 may be implemented as a separate app, possibly as a proxy on the user device or on the network side, which provides content tracking services for the various apps running on the user device.

In some embodiments, CT processor 68 tracks content updates using the disclosed techniques on multiple content sources 24. The identities of the content sources being tracked may be user-device-specific. In some embodiments, the content sources being tracked for a specific user device 28 may be configured by user 32. In other embodiments, the list of content sources being tracked may be generated automatically based on the user activity profile, e.g., based on past Internet activity and past app usage.

### Prefetching Based on Crowd-Sourced Content Tracking

One important use-case of the disclosed techniques, although by no means the only use-case, is content prefetching. In the present context, the term “prefetching” refers to transfer of content from a content source to a user device that is performed not in response to a direct request to consume that specific content by the user. In some cases, the user may trigger a prefetching operation. For example, the user may realize that network service is about to be lost, and trigger prefetching by request “sync-content” or “save for later.” Thus, the term “prefetching” also refers to fetching of content before the time it is needed by the user, and caching the content for later access by the user.

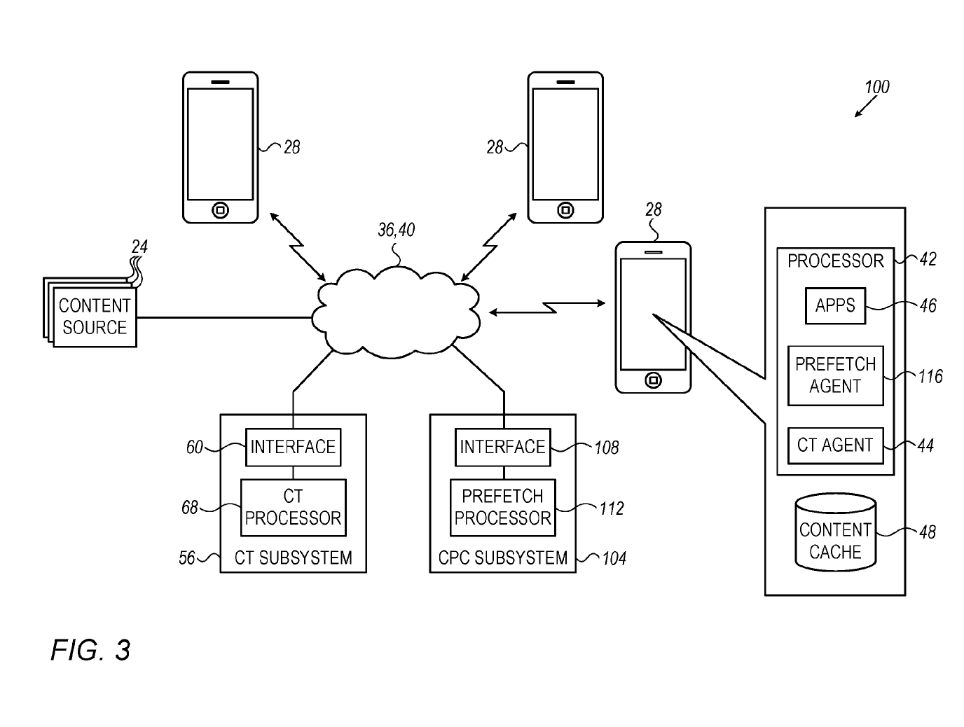

FIG. 3 is a block diagram that schematically illustrates a system 100 for prefetching based on crowd-sourced content tracking, in accordance with an embodiment of the present invention. In system 100, the network side comprises CT subsystem 56, and user devices 28 comprise CT agents 44, similarly to the above-described embodiment of FIG. 1.

In addition, the network side comprises a Content Prefetch Control (CPC) subsystem 104. CPC subsystem 104 comprises a network interface 108 for communicating with network 36, and a prefetch processor 112 that carries out the prefetching control functions of the CPC subsystem. Each user device 28 comprises a respective prefetch agent 116 that carries out prefetching functions on the user-device side.

Certain aspects of prefetching content using this sort of system configuration are addressed in U.S. Patent Application Publication 2016/0021211, entitled “Efficient Content Delivery over Wireless Networks Using Guaranteed Prefetching at Selected Times-Of-Day,” which is assigned to the assignee of the present patent application and whose disclosure is incorporated herein by reference.

Each prefetch agent 116 is typically configured to manage its respective content cache 48, intercept content requests generated in user device 28, and serve the requested content from the cache or from the content sources as appropriate. In some embodiments, agent 116 is also configured to track usage patterns of user 32 for assisting in specifying prefetching policies. Agent 116 may track, for example, the content consumption pattern of the user as a function of time, the geographical location of the user device as a function of time, and the availability of different communication capabilities (e.g., the available bandwidth or the availability of Wi-Fi vs. cellular access) at different times. Agent 116 may also track the characteristics of various available communication channels (e.g., Wi-Fi or cellular), such as congestion level, speed, latency, receiver signal-to-noise ratio (SNR), receiver channel quality indicator (CQI), and/or any other suitable parameters.

Prefetch agent 116 may intercept content requests in user device 28 in various ways. In one embodiment, agent 116 is implemented as an app running in user device 28, embedded in an app running in user device 28, or implemented as a Software Development Kit (SDK) embedded in an app or as part of the user device Operating System (OS). In another embodiment, user device 28 may run a proxy server, which is controlled by agent 116 and is exposed to incoming and outgoing traffic. For example, a proxy application may be used to provide prefetch services to multiple apps as described in U.S. Provisional Patent Application 62/473,389, cited above. Further alternatively, the disclosed techniques can be implemented entirely on the network side without any prefetching agent on the user device side.

Agent 116 typically provides the collected information to prefetch processor 112. In some embodiments agent 116 may track, log and report additional information, such as user device status (e.g., battery status, available memory or CPU resources, or error events) or network status (e.g., network speed and load, or availability of Wi-Fi connectivity). All of these parameters may be considered and used in specifying the prefetching policy.

In some embodiments, prefetch agent 116 may request and receive from processor 112 an updated prefetching policy. Agent 116 may then decide whether to issue a prefetch request based on the policy and other relevant factors (e.g., battery level, network connection quality, content already present in cache 48). The content items can be prefetched via processor 112, or directly from content source 24.

In various embodiments, specifying the prefetching policy may involve estimating, for each content item, the likelihood that user 32 will request access to this content item, possibly within a certain upcoming period of time. These likelihood metrics may be sent to agent 116, in order to assist agent 116 in prioritizing prefetching of different content items. The estimation of the likelihood that a content item will be accessed may consider many factors, such as user-related factors (e.g., gender, location, interests, recent and historical Internet activity), environment-related factors (e.g., time-of-day, traffic conditions, weather, current events, sporting occasions), and/or content-related factors (e.g., content topic/category, content keywords, identity of content source, current popularity/rating of content).

In addition to the likelihood of the user accessing certain content items, the prefetching policy may also consider factors such as power consumption (e.g., preferring to prefetch when Wi-Fi connection is available or when a strong cellular connection is available), transmit cost (e.g., preferring to prefetch during lower-cost times-of-day), network congestion and server load (e.g., preferring to prefetch during off-peak traffic hours), and/or any other suitable user or network related considerations.

Specification of the prefetching policy may also involve associating certain times-of-day with a prefetch operation priority level. This association can be established separately for different apps or content sources, or jointly for multiple apps or content sources. One factor in determining the prefetch priority levels is the estimated likelihood of the user accessing the different apps or content during the various times-of-day.

In some embodiments, the above-described capability of CT processor 68 to identify relationships between content items and/or relationships of content items to dynamic parameters (e.g., user/device identity) can be used for setting the likelihood metrics of the prefetching policy. For example, in an embodiment, CT processor 68 identifies when feeds are personalized, and which content items are likely to be relevant for the feed of each user. Processor 112 may set the likelihood metrics for prefetching based on this information. As another example, in an embodiment, CT processor 68 identifies which representation of a content item may be needed for a particular user or user device. Processor 112 may set the likelihood metrics for prefetching based on this information.

As yet another example, if CT processor 68 can identify that different representations of an image are available depending on device orientation, then the prefetch policy may be set to cause both representations to be prefetched or to give priority to the orientation usually used by the user. As another example, if CT processor 68 finds that two content items are highly correlated over many users (i.e., accessing one item usually indicates that the user will access the other), then prefetch processor 112 may significantly increase the likelihood metrics of one of the items as soon as the other is accessed. As another example, if CT processor 68 finds that several images are contained within some article, then prefetch processor 112 may set the prefetch likelihood metric calculated for the article to impact the metrics assigned for the images.

As yet another example, consider a scenario in which prefetch agent 116 has already prefetched a Wi-Fi representation of an image (e.g., a higher-resolution representation), but then CT processor 68 identifies the existence of a lower-resolution representation of the same image. In an embodiment, CT processor 68 identifies the relationship between the two representations of the image, in order to prevent prefetch processor 112 from deciding that the image has been updated and needs to be prefetched again. Similarly, if the prefetch agent 116 has already prefetched a cellular version of an image (e.g., a lower-resolution representation) but CT processor 68 identifies the existence of a higher-resolution representation of the same image, the prefetch policy may be set to prefetch the higher-resolution image, as well, if the user later has a Wi-Fi connection.

In some embodiments, CT processor 68 assists prefetch processor 112 in tracking the state of a content source 24. For example, CT processor 68 may regularly send updated catalogs to prefetch processor 112, so that prefetch processor 112 is made aware of new or updated content items. This information enables prefetch processor 112 and prefetch agents 116 to keep the prefetched content in caches 48 of user devices 28 up-to-date and synchronized with the content source. The catalog can be included as part of the prefetch policy sent to the user devices, along with any other prefetch rules, strategies, and thresholds defined by prefetch processor 112.

In some embodiments, prefetch agent 116 in a certain user device 28 may request and receive from prefetch processor 112 an updated prefetch policy. Prefetch agent 116 may then decide whether to issue a prefetch request based on this policy, and possibly based on various relevant factors relating to the user device state (e.g., battery level, network connection quality, content already residing in cache 48, and other factors). The prefetching operation can be carried out through prefetch processor 112, or directly between prefetch agent 116 and content source 24. Upon receiving the prefetched content item, the prefetch agent stores the content item in cache 48.

In an embodiment, prefetch agent 116 may receive a request to access a certain content item by user 32 (e.g., through an app 46) and determine whether the desired content item already resides in cache 48. If so, the prefetch agent may retrieve the required content item from cache 48. Otherwise, the required content item may be retrieved from content sources 24 over the network. The prefetch agent can also report historical usage patterns and other relevant information relating to the user device or the network to prefetch processor 112. This information enables prefetch processor 112 to better set the prefetch policy.

In some embodiments, some user devices 28 may comprise only prefetch agent 116, or only CT agent 44, but not both. In such cases, user devices that comprise a CT agent 44 (but possibly no prefetch agent 116) would support the tracking of content sources that may benefit other user devices that support prefetching (but possibly not crowd-sourced content tracking).

The configurations of system 20, system 100 and their various elements, as shown in FIGS. 1 and 3, are example configurations that are chosen purely for the sake of conceptual clarity. In alternative embodiments, any other suitable configurations can be used. For example, the functions of CT subsystem 56 and/or CPC subsystem 104 can be implemented using any desired number of processors, or even in a single processor. The various system functions can be partitioned among the processors in any suitable way. CT subsystem 56 and/or CPC subsystem 104 may be implemented as a cloud application, e.g., using private or public cloud resources. In some embodiments, CT subsystem 56 and/or CPC subsystem 104 may be merged and implemented as a single content-tracking and prefetch-control subsystem, even on a single processor. Additionally or alternatively, CT agent 44 and prefetch agent 116 in a given user device 28 may be implemented as a single content-tracking and prefetch agent.

The different elements of systems 20 and/or 100 may be implemented using suitable software, using suitable hardware, e.g., using one or more Application-Specific Integrated Circuits (ASICs) or Field-Programmable Gate Arrays (FPGAs), or using a combination of hardware and software elements. Content cache 48 and content catalog 76 may be implemented using any suitable memory or storage device. In some embodiments, processors 42, 68 and/or 112 are implemented using one or more general-purpose processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
detecting, by a plurality of user devices that access content on one or more content sources, content updates that occurred on the content sources, and reporting the content updates to a content-tracking processor;
collecting the content updates, reported by the plurality of user devices, at the content-tracking processor; and
distributing at least some of the collected content updates to one or more user devices.

2. The method according to claim 1, wherein detecting the content updates comprises, in a user device, looking-up a content item accessed by the user device in a content catalog cached in the user device.

3. The method according to claim 2, wherein distributing the content updates comprises updating the cached content catalog.

4. The method according to claim 2, wherein looking-up the content item comprises one of:
detecting that the content item is not listed in the cached catalog; and
detecting that a version of the content item being accessed by the user device differs from the version of the content item listed in the cached catalog.

5. The method according to claim 1, further comprising, in response to a detected update of a first content item, identifying that a second content item is related to the first content item, and wherein distributing the content updates comprises notifying the one or more user devices of a relationship between the first and second content items.

6. The method according to claim 5, wherein identifying that the second content item is related to the first content item comprises identifying that the second content item has a parent-child relationship with the first content item.

7. The method according to claim 5, wherein identifying that the second content item is related to the first content item comprises identifying that the first and second content items are predicted to be accessed by the same user.

8. The method according to claim 5, wherein identifying that the second content item is related to the first content item comprises identifying that the first and second content items comprise different representations of a same content.

9. The method according to claim 1, further comprising identifying that a given content item is personalized, and wherein distributing the content updates comprises selecting, based on the identification, which user devices to notify of a content update relating to the given content item.

10. The method according to claim 1, further comprising identifying that a given content item changes dynamically based on a parameter, and wherein distributing the content updates comprises notifying the one or more user devices that the given content item is identified as changing dynamically.

11. The method according to claim 1, wherein collecting the content updates comprises combining the content updates reported by the user devices with additional content updates detected by crawler software that scans at least one of the content sources.

12. The method according to claim 1, wherein distributing the content updates comprises distributing a given content update to only a selected subset of the user devices.

13. The method according to claim 1, wherein reporting the content updates comprises reporting, from a user device to the content-tracking processor, metadata relating to (i) content items accessed by the user device, or (ii) a state of the user device or a user of the user device while accessing the content items.

14. The method according to claim 13, wherein collecting and distributing the content updates is performed responsively to the metadata.

15. The method according to claim 13, and comprising identifying a relationship pertaining to one or more of the content items, responsively to the metadata.

16. The method according to claim 1, wherein accessing the content by the user devices comprises prefetching one or more of the content items, responsively to the content updates distributed by the content-tracking processor.

17. The method according to claim 16, further comprising, in response to a detected update of a first content item, identifying by the content-tracking processor a relationship between the first content item and a second content item, wherein prefetching the content items comprises setting a prefetching policy based on the identified relationship.

18. The method according to claim 1, wherein distributing the content updates comprises distributing a content update, which was collected from a first user device, to a second user device that is different from the first user device.

19. The method according to claim 1, and comprising using a content update, which was collected from a first user device, only by one or more second user devices that are different from the first user device.

20. A system, comprising:
a plurality of user devices, configured to access content on one or more content sources, to detect content updates that occurred on the content sources, and to report the content updates; and
a content-tracking processor, configured to collect the content updates reported by the plurality of user devices, and to distribute at least some of the content updates to one or more user devices.

21. The system according to claim 20, wherein a user device is configured to detect a content update by looking-up a content item accessed by the user device in a content catalog cached in the user device.

22. The system according to claim 21, wherein the content-tracking processor is configured to distribute the content updates by updating the cached content catalog.

23. The system according to claim 21, wherein the user device is configured to detect the content update by performing one of:
detecting that the content item is not listed in the cached catalog; and
detecting that a version of the content item being accessed by the user device differs from the version of the content item listed in the cached catalog.

24. The system according to claim 20, wherein, in response to a detected update of a first content item, the content-tracking processor is configured to identify that a second content item is related to the first content item, and to notify one or more of the user devices of a relationship between the first and second content items.

25. The system according to claim 24, wherein the content-tracking processor is configured to identify that the second content item has a parent-child relationship with the first content item.

26. The system according to claim 24, wherein the content-tracking processor is configured to identify that the first and second content items are predicted to be accessed by the same user.

27. The system according to claim 24, wherein the content-tracking processor is configured to identify that the first and second content items comprise different representations of a same content.

28. The system according to claim 20, wherein the content-tracking processor is configured to identify that a given content item is personalized, and to select, based on the identification, which user devices to notify of a content update relating to the given content item.

29. The system according to claim 20, wherein the content-tracking processor is configured to identify that a given content item changes dynamically based on a parameter, and to notify the one or more user devices that the given content item is identified as changing dynamically.

30. The system according to claim 20, wherein the content-tracking processor is configured to combine the content updates reported by the user devices with additional content updates detected by crawler software that scans at least one of the content sources.

31. The system according to claim 20, wherein the content-tracking processor is configured to distribute a given content update to only a selected subset of the user devices.

32. The system according to claim 20, wherein a user device is configured to report to the content-tracking processor metadata relating to (i) content items accessed by the user device, or (ii) a state of the user device or a user of the user device while accessing the content items.

33. The system according to claim 32, wherein the content-tracking processor is configured to collect and distribute the content updates responsively to the metadata.

34. The system according to claim 32, wherein the content-tracking processor is configured to identify a relationship pertaining to one or more of the content items, responsively to the metadata.

35. The system according to claim 20, wherein the user devices are configured to prefetch one or more of the content items, responsively to the content updates distributed by the content-tracking processor.

36. The system according to claim 35, wherein, in response to a detected update of a first content item, the content-tracking processor is configured to identify a relationship between the first content item and a second content item, and to set a prefetching policy based on the identified relationship.

37. The system according to claim 20, wherein the content-tracking processor is configured to distribute a content update, which was collected from a first user device, to a second user device that is different from the first user device.

38. The system according to claim 20, wherein the user devices are configured to access the content responsively to the content updates distributed by the content-tracking processor.

39. An apparatus, comprising:
an interface for communicating over a communication network; and
a processor, configured to:
receive over the communication network, from a plurality of user devices that access content on one or more content sources, content updates that occurred on the content sources and were detected by the user devices;
collect the content updates reported by the plurality of user devices; and
distribute at least some of the content updates to one or more user devices.

40. The method according to claim 1, and comprising accessing the content by at least one user device responsively to the content updates distributed by the content-tracking processor.
